(19) United States
(12) Patent Application Publication
(10) Pub. No.: US 2020/0316714 A1
(43) Pub. Date: Oct. 8, 2020

(54) INTEGRATED PREDRILLING AND LASER SPOT WELDING OF COATED STEELS

(71) Applicant: GM GLOBAL TECHNOLOGY OPERATIONS LLC, Detroit, MI (US)

(72) Inventors: David Yang, Shanghai (CN); Wu Tao, Shanghai (CN)

(21) Appl. No.: 16/085,901

(22) PCT Filed: Apr. 14, 2016
(86) PCT No.: PCT/CN2016/079228

§ 371 Date: Sep. 17, 2018

(51) Int. Cl. B23K 26/22; B23K 26/322; B23K 26/60; B23K 26/34; B23K 26/082; B23K 26/06

(52) U.S. Cl. CPC B23K 26/22; B23K 26/322; B23K 26/60; B23K 2101/34; B23K 26/082; B23K 26/0643; B23K 26/34

(57) ABSTRACT

A method of laser spot welding a workpiece stack-up (10) includes initially forming at least one hole (74) in the workpiece stack-up and, thereafter, forming a laser spot weld joint (86). The formation of the laser spot weld joint involves directing a welding laser beam (24) at the top surface (20) of the workpiece stack-up to create a molten steel weld pool (98) that penetrates into the stack-up, and then advancing the welding laser beam relative to a plane of the top surface of the workpiece stack-up along a beam travel pattern (102) that lies within an annular weld area (90). The beam travel pattern of the welding laser beam surrounds a center area (96) on the plane of the top surface that spans the at least one hole formed in the workpiece stack-up. The workpiece stack-up includes at least two overlapping steel workpieces, at least one of which includes a surface coating of a zinc-based material. This method can minimize porosity within the weld joint.

### TECHNICAL FIELD

The technical field of this disclosure relates generally to laser welding and, more particularly, to a method of laser spot welding together two or more overlapping steel workpieces in which at least one of the steel workpieces includes a zinc-based surface coating.

### BACKGROUND

Laser spot welding is a metal joining process in which a laser beam is directed at a metal workpiece stack-up to provide a concentrated energy source capable of effectuating a weld joint between the overlapping constituent metal workpieces. In general, two or more metal workpieces are first aligned and stacked relative to one another such that their faying surfaces overlap and confront to establish a faying interface (or faying interfaces) that extends through an intended weld site. A laser beam is then directed towards and impinges a top surface of the workpiece stack-up. The heat generated from the absorption of energy from the laser beam initiates melting of the metal workpieces and creates a molten weld pool within the workpiece stack-up. And, if the power density of the laser beam is high enough, a keyhole is produced directly underneath the laser beam and is surrounded by the molten weld pool. A keyhole is a column of vaporized metal derived from the metal workpieces within the workpiece stack-up that may include plasma.

The laser beam creates the molten weld pool in very short order upon impinging the top surface of the workpiece stack-up. Once created, the molten weld pool grows as the laser beam continues to deliver energy to the workpiece stack-up. The molten weld pool eventually grows to penetrate through the metal workpiece impinged by the laser beam and into the underlying metal workpiece or workpieces to a depth that intersects each of the established faying interfaces. The general shape and penetration depth of the molten weld pool can be managed by controlling various characteristics of the laser beam including its power, travel velocity (if any), and focal position. When the molten weld pool has stabilized and reached the desired penetration depth in the workpiece stack-up, and optionally been advanced along the top surface of the stack-up, the transmission of the laser beam is ceased so that it no longer impinges the stack-up at the weld site. The molten weld pool quickly cools and solidifies (and collapses the keyhole if present) to form a laser spot weld joint comprised or resolidified composite workpiece material derived from each of the workpieces penetrated by molten weld pool. The resolidified composite workpiece material of the laser spot weld joint autogenously fusion welds the overlapping workpieces together at the weld site.

The automotive industry is interested in using laser spot welding to manufacture parts that can be installed on a vehicle. In one example, a vehicle door body may be fabricated from an inner door panel and an outer door panel that are joined together by a plurality of laser spot weld joints. The inner and outer door panels are first stacked relative to each other and secured in place by clamps. A laser beam is then sequentially directed at multiple weld sites around the stacked panels in accordance with a programmed sequence to form the plurality of laser spot weld joints as previously described. The process of laser spot welding inner and outer door panels—as well as other vehicle part components such as those used to fabricate hoods, deck lids, body structures such as body sides and cross-members, load-bearing structural members, etc.—is typically an automated process that can be carried out quickly and efficiently. The aforementioned desire to laser spot weld metal workpieces is not unique to the automotive industry; indeed, it extends to other industries that may utilize laser spot welding including the aviation, maritime, railway, and building construction industries, among others.

The use of laser spot welding to join together coated metal workpieces that are often used in manufacturing practices can present challenges. For example, steel workpieces often include a zinc-based surface coating for corrosion protection. Zinc has a boiling point of about 906° C., while the melting point of the base steel substrate it coats is typically greater than 1300° C. Thus, when a steel workpiece that includes a zinc-based surface coating is laser spot welded, high-pressure zinc vapors are readily produced at the surfaces of the steel workpiece and have a tendency to disrupt the laser welding process. In particular, the zinc vapors produced at the faying interface(s) of the steel workpieces are forced to diffuse into and through the molten weld pool created by the laser beam unless an alternative escape outlet is provided through the workpiece stack-up. When an adequate escape outlet is not provided, zinc vapors may remain trapped in the molten weld pool as it cools and solidifies, which may lead to defects in the resulting weld joint—such as entrained porosity that can degrade the mechanical properties of the laser spot weld joint to such an extent that the joint may be deemed non-conforming.

To deter high-pressure zinc vapors from diffusing into the molten weld pool, conventional manufacturing procedures have called for laser scoring or mechanical dimpling at least one of the two steel workpieces at each faying interface where a zinc-based coating is present before laser spot welding is conducted. The laser scoring or mechanical dimpling processes create spaced apart protruding features that impose a gap of about 0.1-0.2 millimeters between the faying surface on which they have been formed and the confronting faying surface of the adjacent steel workpiece, which provides an escape path to guide zinc vapors along the established faying interface and away from the weld site. But the formation of these protruding features adds an additional step to the overall laser spot welding process and is believed to contribute to the occurrence of undercut weld joints. It would be a welcome addition to the art if two or more steel workpieces—at least one of which includes a surface coating of a zinc-based material—could be laser spot welded together without having to necessarily score or mechanically dimple any of the steel workpieces in order to consistently form a durable weld joint with sufficient strength.

### SUMMARY OF THE DISCLOSURE

A method of laser spot welding a workpiece stack-up that includes overlapping steel workpieces is disclosed. The workpiece stack-up includes two or more steel workpieces, and at least one of those steel workpieces (and possibly all of the steel workpieces) includes a surface coating of a zinc-based material such as zinc or a zinc-iron alloy. The zinc-based surface coating preferably has a thickness that ranges from 2 μm to 30 μm. And while a zinc-based surface coating protects the underlying steel from corrosion, among other notable benefits, it can evolve high pressure zinc vapors when heated during laser spot welding. The evolution of such zinc vapors, in turn, can be a source of porosity in the laser spot weld joint and can also lead to other abnormalities such as spatter. The disclosed laser spot welding method minimizes the impact that zinc-based surface coatings may have on the laser spot weld joint without requiring—but of course not prohibiting—the practice of certain procedures such as, for example, the intentional imposition of gaps between the steel workpieces at the faying interface where the zinc-based surface coating is present by way of laser scoring or mechanical dimpling.

To begin, the laser spot welding method involves providing a workpiece stack-up that includes two or more overlapping steel workpieces. The steel workpieces are stacked together such that a faying interface is formed between the faying surfaces of each pair of adjacent overlapping steel workpieces. For example, in one embodiment, the workpiece stack-up includes first and second steel workpieces having first and second faying surfaces, respectively, that overlap and confront one another to establish a single faying interface. In another embodiment, the workpiece stack-up includes an additional third steel workpiece situated between the first and second steel workpieces. In this way, the first and second steel workpieces have first and second faying surfaces, respectively, that overlap and confront opposed faying surfaces of the third steel workpiece to establish two faying interfaces. When a third steel workpiece is present, the first and second steel workpieces may be separate and distinct parts or, alternatively, they may be different portions of the same part, such as when an edge of one part is folded over a free edge of another part.

After the workpiece stack-up is provided, and prior to the practice of laser spot welding, at least one hole is formed in the workpiece stack-up. The at least one hole extends at least part of the way through the workpiece stack-up and traverses each faying interface established within the workpiece stack-up. As such, the at least one hole may partially penetrate into the workpiece stack-up from the top surface towards the bottom surface, in which case the at least one hole is open at the top surface, or the at least one hole may partially penetrate into the workpiece stack-up from the bottom surface towards the top surface, in which case the at least one hole is open at the bottom surface. In a preferred embodiment, though, the at least one hole fully penetrates through the workpiece stack-up and is therefore open at both the top and bottom surfaces of the workpiece stack-up. And while the number of holes formed in the workpiece stack-up may vary, in many instances the number of holes ranges from one to eight depending on the size of the holes in relation to the expected size of the laser weld joint to be formed as well as the compositions of the steel workpieces within the stack-up.

Following the formation of the at least one hole, a welding laser beam is directed at, and impinges, a top surface of the workpiece stack-up to create a molten steel weld pool that penetrates into the workpiece stack-up from the top surface towards the bottom surface. The power density of the welding laser beam is selected to carry out the laser spot welding portion of the disclosed method, in which the laser weld joint is formed, in either conduction welding mode or keyhole welding mode. In conduction welding mode, the power density of the welding laser beam is relatively low, and the energy of the welding laser beam is conducted as heat through the steel workpieces to create only the molten steel weld pool. In keyhole welding mode, on the other hand, the power density of the welding laser beam is high enough to vaporize the steel workpieces and produce a keyhole directly underneath the welding laser beam within the molten steel weld pool. The keyhole provides a conduit for energy absorption deeper into workpiece stack-up which, in turn, facilitates deeper and narrower penetration of the molten steel weld pool. The molten steel weld pool and the keyhole, if formed, may fully or partially penetrate the workpiece stack-up.

The welding laser beam is advanced relative to a plane of the top surface of the workpiece stack-up along a beam travel pattern following creation of the molten weld pool and, optionally, the keyhole. Advancing the welding laser beam along the beam travel pattern translates the keyhole and the molten steel weld pool along a route that corresponds to the patterned movement of the welding laser beam relative to the top surface of the workpiece stack-up. Such advancement of the welding laser beam along the beam travel pattern leaves behind a trail of molten steel workpiece material in the wake of the welding laser beam and the corresponding route of the molten steel weld pool. This trail of molten steel workpiece material quickly cools and solidifies into resolidified composite steel workpiece material that is comprised of steel material from each steel workpiece penetrated by the molten steel weld pool. The collective resolidified composite steel workpiece material obtained from advancing the welding laser beam along the beam travel pattern provides a laser spot weld joint that autogenously fusion welds the workpieces together. After the welding laser beam has completed its advancement along the beam travel pattern, the welding laser beam is removed from the top surface of the workpiece stack-up, typically by halting transmission of the welding laser beam to terminate energy transfer to the workpiece stack-up.

The beam travel pattern traced by the welding laser beam includes one or more weld paths that lie within an annular weld area as projected onto the plane (the x-y plane) of the top surface of the workpiece stack-up. The annular weld area is defined by an outer diameter boundary and an inner diameter boundary. The beam travel pattern of the welding laser beam surrounds a center area encircled by the annular weld area—more specifically encircled by the inner diameter boundary of the annular weld area—on the plane of the top surface. The annular weld area can include a circular outer diameter boundary and a circular inner diameter boundary when projected onto the plane of the top surface, although different geometric shapes are certainly possible. As the welding laser beam moves along the beam travel pattern within the annular weld area, it does so without impinging on the center area. This type of patterned movement of the welding laser beam has the effect of driving any zinc vapors, which are produced by heating the zinc-based surface coating(s) included within the workpiece stack-up, towards the at least one hole so that the zinc vapors can be quickly vented from the stack-up. As a result of guiding zinc vapors towards the at least one hole and expelling those vapors from the stack-up, the composite resolidified steel workpiece material that constitutes the laser weld joint is less liable to include a debilitating amount of entrained porosity.

In a preferred embodiment, a remote laser welding apparatus is used to form both the at least one hole and the laser spot weld joint in the workpiece stack-up. The remote laser welding apparatus includes a scanning optic laser head that houses optical components that can move a laser beam relative to the plane at the top surface of the workpiece stack-up and also adjust a focal point of the laser beam up or down along a longitudinal axis of the laser beam. Different laser beams can thus be transmitted from the scanning optic laser head to form, in sequence, the at least one hole and the laser spot weld joint. In particular, to form the at least one hole, a pre-welding laser beam is directed at, and impinges, the top surface of the workpiece stack-up. The pre-welding laser beam is provided with an appropriate power level and may be moved in the plane of the top surface and/or the focal point of the pre-welding laser beam may be moved along the longitudinal axis of the beam to expel molten steel from the workpiece, thus creating a hole that preferably, but not necessarily, fully penetrates the workpiece stack-up in that it extends from the top surface to the bottom surface and is open at each of those surfaces. A single hole or multiple holes may be formed. After the at least one hole is formed with the pre-welding laser beam, the welding laser beam is directed at, and impinges, the top surface of the workpiece stack-up within the annular weld area and is advanced along the beam travel pattern to form the laser spot weld joint.

### BRIEF DESCRIPTION OF THE DRAWINGS

FIG. 1 is a perspective view of an embodiment of a remote laser welding apparatus for forming at least one hole in a workpiece stack-up that includes overlapping steel workpieces followed by forming a laser spot weld joint;

FIG. 1A is a magnified view of the general laser beam depicted in FIG. 1 showing a focal point and a longitudinal beam axis of the general laser beam;

FIG. 2 is a plan view of a top surface of the workpiece stack-up illustrating the use of a pre-welding laser beam to form the at least one hole and, subsequently, the use of a welding laser beam to form the laser spot weld joint, and wherein each of the pre-welding laser beam and the welding laser beam are transmitted to the top surface of the workpiece stack-up by the remote laser welding apparatus;

FIG. 3 is a cross-sectional view (taken along line 3-3) of the workpiece stack-up depicted in FIG. 2 along with the at least one hole formed in the workpiece stack-up by the pre-welding laser beam;

FIG. 4 is a cross-sectional view (taken along line 4-4) of the workpiece stack-up depicted in FIG. 2 along with a molten steel weld pool and a keyhole produced by the welding laser beam subsequent to formation of the at least one hole by the pre-welding laser beam;

FIG. 5 depicts an embodiment of the beam travel pattern as projected onto the top surface of the workpiece stack-up that may be traced by the welding laser beam, and thus followed by the keyhole and surrounding molten steel weld pool, during formation of a laser spot weld joint between the overlapping steel workpieces included in the workpiece stack-up;

FIG. 6 depicts another embodiment of the beam travel pattern as projected onto the top surface of the workpiece stack-up that may be traced by the welding laser beam, and thus followed by the keyhole and surrounding molten steel weld pool, during formation of a laser spot weld joint between the overlapping steel workpieces included in the workpiece stack-up;

FIG. 7 depicts yet another embodiment of a beam travel pattern as projected onto the top surface the workpiece stack-up that is similar to the beam travel pattern shown in FIG. 6;

FIG. 8 depicts still another embodiment of the beam travel pattern as projected onto the top surface of the workpiece stack-up that may be traced by the welding laser beam, and thus followed by a keyhole and surrounding molten steel weld pool, during formation of a laser spot weld joint between the overlapping steel workpieces included in the workpiece stack-up;

FIG. 9 is a cross-sectional side view of the workpiece stack-up taken from the same perspective as FIG. 3 along with the at least one hole formed in the workpiece stack-up by the pre-welding laser beam, although here the workpiece stack-up includes three steel workpieces that establish two faying interfaces, as opposed to two steel workpieces that establish a single faying interface as depicted in FIG. 3; and

FIG. 10 is a cross-sectional side view of the workpiece stack-up taken from the same perspective as FIG. 4 along with a molten steel weld pool and a keyhole produced by the welding laser beam subsequent to formation of the at least one hole by the pre-welding laser beam, although here the workpiece stack-up includes three steel workpieces that establish two faying interfaces, as opposed to two steel workpieces that establish a single faying interface as depicted in FIG. 4.

### DETAILED DESCRIPTION

The disclosed method of laser spot welding a workpiece stack-up comprised of two or more overlapping steel workpieces involves, first, forming at least one hole in the workpiece stack-up that intersects each faying interface established within the stack-up and, second, forming a laser spot weld joint by impinging a top surface of the workpiece stack-up with a welding laser beam and advancing the welding laser beam relative to a plane of the top surface along a beam travel pattern confined within an annular weld area. The annular weld area and, thus, the beam travel pattern, surrounds a center area that spans the at least one hole previously formed in the workpiece stack-up. Such patterned movement of the welding laser beam within the annular weld area drives zinc vapors that may be produced by the heat of the welding laser beam towards the at least one hole so as to limit the or altogether eliminate entrained porosity within the composite resolidified steel workpiece material that constitutes the laser spot weld joint. Indeed, if any porosity is present, the conductive heat transfer that emanates radially inward from the annular weld area during laser welding has the affect of sweeping porosity into a region of the laser spot weld joint beneath the center area on the plane of the top surface of the workpiece stack-up. This is noteworthy since centrally located porosity is less likely to affect the mechanical properties of the laser spot weld joint compared to porosity located at the perimeter of the joint.

The at least one hole and the laser spot weld joint can be formed by a variety of techniques using the same or different devices. For example, the at least one hole may be formed by mechanical drilling via a rotating drill bit or, like the subsequently formed laser spot weld joint, by laser welding. Any type of laser welding apparatus, including remote and conventional laser welding apparatuses, may be employed to form the at least one hole and the laser spot weld joint in succession using a pre-welding laser beam and a welding laser beam, respectively, that differ in their beam characteristics (e.g., power level, focal point location, travel speed, etc.). Each of the pre-welding laser beam and the welding laser beam may be a solid-state laser beam or a gas laser beam depending on the characteristics of the steel workpieces being joined and the laser welding apparatus being used. Some notable solid-state lasers that may be used are a fiber laser, a disk laser, a direct diode laser, and a Nd:YAG laser, and a notable gas laser that may be used is a CO₂ laser, although other types of lasers may certainly be used. In a preferred implementation of the disclosed method, which is described below in more detail, a remote laser welding apparatus is operated to sequentially form both the at least one hole and the laser spot weld joint through the use of a solid-state state laser that can transition between the pre-welding laser beam and the welding laser beam.

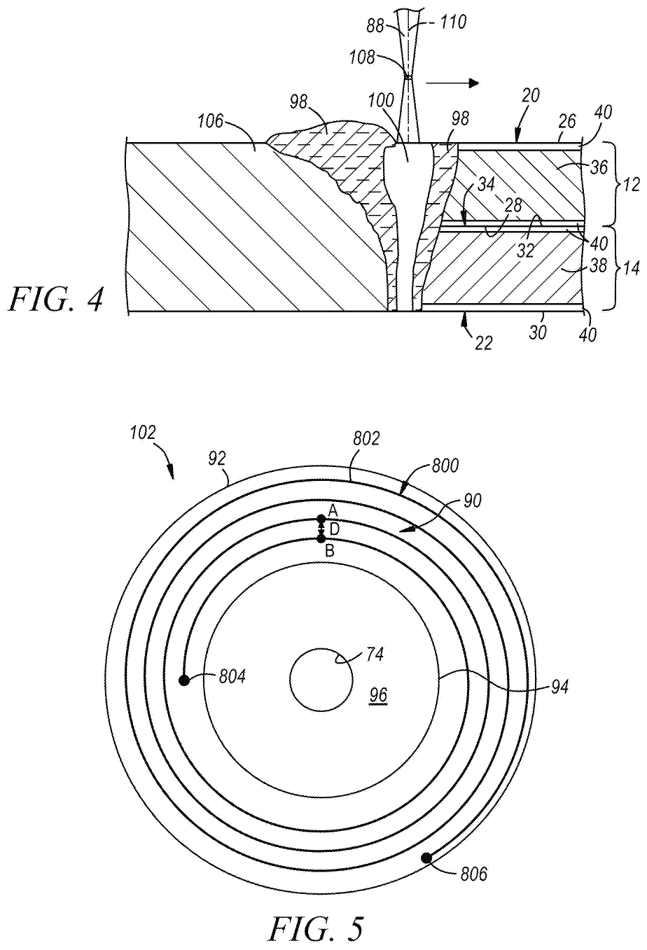

The laser spot welding method may be performed on a variety of workpiece stack-up configurations. For example, the disclosed method may be used in conjunction with a “2T” workpiece stack-up (FIGS. 3-4) that includes two overlapping and adjacent steel workpieces, or it may be used in conjunction with a “3T” workpiece stack-up (FIGS. 9-10) that includes three overlapping and adjacent steel workpieces. Still further, in some instances, the disclosed method may be used in conjunction with a “4T” workpiece stack-up (not shown) that includes four overlapping and adjacent steel workpieces. Additionally, the several steel workpieces included in the workpiece stack-up may have similar or dissimilar strengths and grades, and may have similar or dissimilar thicknesses at the weld site, if desired. The laser spot welding method is carried out in essentially the same way to achieve the same results regardless of whether the workpiece stack-up includes two overlapping steel workpieces or more than two overlapping steel workpieces. Any differences in workpiece stack-up configurations can be easily accommodated by adjusting the characteristics of the pre-welding laser beam (if used) and the welding laser beam to achieve the same end result.

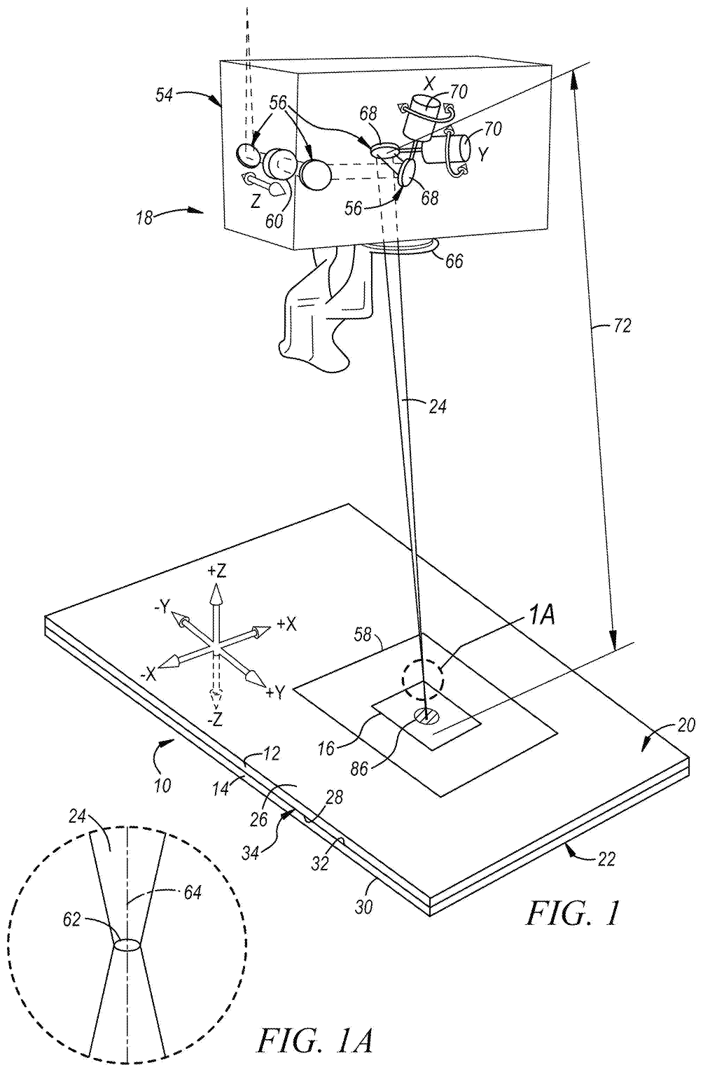

Referring now to FIGS. 1-8, a method of laser spot welding a workpiece stack-up 10 is shown in which the stack-up 10 includes a first steel workpiece 12 and a second steel workpiece 14 that overlap at a weld site 16 where laser spot welding is conducted using a remote laser welding apparatus 18. The first and second steel workpieces 12, 14 provide a top surface 20 and a bottom surface 22, respectively, of the workpiece stack-up 10. The top surface 20 of the workpiece stack-up 10 is made available to the remote laser welding apparatus 18 and is accessible by a laser beam 24 emanating from the remote laser welding apparatus 18. And since only single side access is needed to conduct laser spot welding, there is no need for the bottom surface 22 of the workpiece stack-up 10 to be made available to the remote laser welding apparatus 18 in the same way as the top surface 20. Moreover, while only one weld site 16 is depicted in the Figures for the sake of simplicity, skilled artisans will appreciate that laser welding in accordance with the disclosed laser spot welding method can be practiced at multiple different weld sites spread throughout the same workpiece stack-up.

The workpiece stack-up 10 may include only the first and second steel workpieces 12, 14, as shown in FIGS. 1 and 3-4. Under these circumstances, and as shown best in FIG. 3, the first steel workpiece 12 includes an exterior outer surface 26 and a first faying surface 28, and the second steel workpiece 14 includes an exterior outer surface 30 and a second faying surface 32. The exterior outer surface 26 of the first steel workpiece 12 provides the top surface 20 of the workpiece stack-up 10 and the exterior outer surface 30 of the second steel workpiece 14 provides the oppositely-facing bottom surface 22 of the stack-up 10. And, since the two steel workpieces 12, 14 are the only workpieces present in the workpiece stack-up 10, the first and second faying surfaces 28, 32 of the first and second steel workpieces 12, 14 overlap and confront to establish a faying interface 34 that extends through the weld site 16. In other embodiments, one of which is described below in connection with FIGS. 9-10, the workpiece stack-up 10 may include an additional steel workpiece disposed between the first and second steel workpieces 12, 14 to provide the stack-up 10 with three steel workpieces instead of two.

The term “faying interface” is used broadly in the present disclosure and is intended to encompass a wide range of overlapping relationships between the confronting first and second faying surfaces 28, 32 that can accommodate the practice of laser spot welding. For instance, the faying surfaces 28, 32 may establish the faying interface 34 by being in direct or indirect contact. The faying surfaces 28, 32 are in direct contact with each other when they physically abut and are not separated by a discrete intervening material layer or gaps that fall outside of normal assembly tolerance ranges. The faying surfaces 28, 32 are in indirect contact when they are separated by a discrete intervening material layer such as a structural adhesive—and thus do not experience the type of interfacial abutment that typifies direct contact—yet are in close enough proximity that laser spot welding can be practiced. As another example, the faying surfaces 28, 32 may establish the faying interface 34 by being separated by gaps that are purposefully imposed. Such gaps may be imposed between the faying surfaces 28, 32 by creating protruding features on one or both of the faying surfaces 28, 32 through laser scoring, mechanical dimpling, or otherwise. The protruding features maintain intermittent contact points between the faying surfaces 28, 32 that keep the faying surfaces 28, 32 spaced apart outside of and around the contact points by up to 1.0 mm and preferably, between 0.2 mm and 0.8 mm.

As shown best in FIG. 3, the first steel workpiece 12 includes a first base steel substrate 36 and the second steel workpiece 14 includes a second base steel substrate 38. Each of the base steel substrates 36, 38 may be separately composed of any of a wide variety of steels including a low carbon steel (also commonly referred to as mild steel), interstitial-free (IF) steel, bake-hardenable steel, high-strength low-alloy (HSLA) steel, dual-phase (DP) steel, complex-phase (CP) steel, martensitic (MART) steel, transformation induced plasticity (TRIP) steel, twining induced plasticity (TWIP) steel, and boron steel such as when the steel workpiece 12, 14 includes press-hardened steel (PHS). Moreover, each of the first and second base steel substrates 36, 38 may be treated to obtain a particular set of mechanical properties, including being subjected to heat-treatment processes such as annealing, quenching, and/or tempering. The first and second steel workpieces 12, 14 may be hot or cold rolled to their final thicknesses and may be pre-fabricated to have a particular profile suitable for assembly into the workpiece stack-up 10.

At least one of the first or second steel workpieces 12, 14—and preferably both—includes a surface coating 40 that overlies the base steel substrate 36, 38. As shown in FIG. 3, each of the first and second base steel substrates 36, 38 is coated with a surface coating 40 that, in turn, provides the steel workpieces 12, 14 with their respective exterior outer surfaces 26, 30 and their respective faying surfaces 28, 32. The surface coating 40 applied to one or both of the base steel substrates 36, 38 is a zinc-based material. Some examples of a zinc-based material include zinc or a zinc-iron alloy that preferably has a bulk average composition that includes 8 wt % to 12 wt % iron and 0.5 wt % to 4 wt % aluminum with the balance (in wt %) being zinc. A coating of a zinc-based material may be applied by hot-dip galvanizing (zinc coating), electro-galvanizing (zinc coating), or galvannealing (zinc-iron alloy coating), typically to a thickness of between 2 μm and 50 μm, although other coating procedures and thicknesses of the attained coatings may be employed. Taking into the account the thickness of the base steel substrates 36, 38 and their optional surface coatings 40, each of the first and second steel workpieces 12, 14 has a thickness 120, 140 that preferably ranges from 0.4 mm to 4.0 mm, and more narrowly from 0.5 mm to 2.0 mm, at least at the weld site 16. The thicknesses 120, 140 of the first and second steel workpieces 12, 14 may be the same of different from each other.

Referring back to FIG. 1, the remote laser welding apparatus 18 includes a scanning optic laser head 54. The scanning optic laser head 54 directs the laser beam 24 at the top surface 20 of the workpiece stack-up 10 which, here, is provided by the outer surface 26 of the first steel workpiece 12. The scanning optic laser head 54 is preferably mounted to a robotic arm (not shown) that can quickly and accurately carry the laser head 54 to many different preselected weld sites 16 on the workpiece stack-up 10 in rapid programmed succession. The laser beam 24 used in conjunction with the scanning optic laser head 54 is preferably a solid-state laser beam operating with a wavelength in the near-infrared range (commonly considered to be 700 nm to 1400 nm) of the electromagnetic spectrum. Additionally, the laser beam 24 has a power level capability that can attain a power density sufficient to expel molten steel from the workpiece stack-up 10 during formation of the at least one hole and to produce a keyhole, if desired, within the workpiece stack-up 10 during formation of the laser spot weld joint. The power density needed to produce a keyhole within overlapping steel workpieces is typically in the range of 0.5-1.0 MW/cm².

Some examples of a suitable solid-state laser beam that may be used in conjunction with the remote laser welding apparatus 18 include a fiber laser beam, a disk laser beam, and a direct diode laser beam. A preferred fiber laser beam is a diode-pumped laser beam in which the laser gain medium is an optical fiber doped with a rare earth element (e.g., erbium, ytterbium, neodymium, dysprosium, praseodymium, thulium, etc.). A preferred disk laser beam is a diode-pumped laser beam in which the gain medium is a thin laser crystal disk doped with a rare earth element (e.g., a ytterbium-doped yttrium-aluminum garnet (Yb:YAG) crystal coated with a reflective surface) and mounted to a heat sink. And a preferred direct diode laser beam is a combined laser beam (e.g., wavelength combined) derived from multiple diodes in which the gain medium is semiconductors such as those based on aluminum gallium arsenide (AlGaAS) or indium gallium arsenide (InGaAS). Other solid-state laser beams not specifically mentioned here may of course be used.

The scanning optic laser head 54 includes an arrangement of mirrors 56 that can maneuver the laser beam 24 relative to a plane oriented along the top surface 20 of the workpiece stack-up 10 within an operating envelope 58 that encompasses the weld site 16. Here, as illustrated in FIG. 1, the plane of the top surface 20 spanned by the operating envelope 58 is labeled the x-y plane since the position of the laser beam 24 within the plane is identified by the “x” and “y” coordinates of a three-dimensional coordinate system. In addition to the arrangement of mirrors 56, the scanning optic laser head 54 also includes a z-axis focal lens 60, which can move a focal point 62 (FIG. 1A) of the laser beam 24 along a longitudinal axis 64 of the laser beam 24 to thus vary the location of the focal point 62 in a z-direction that is oriented perpendicular to the x-y plane in the three-dimensional coordinate system established in FIG. 1. Furthermore, to keep dirt and debris from adversely affecting the optical system components and the integrity of the laser beam 24, a cover slide 66 may be situated below the scanning optic laser head 54. The cover slide 66 protects the arrangement of mirrors 56 and the z-axis focal lens 60 from the surrounding environment yet allows the laser beam 24 to pass out of the scanning optic laser head 54 without substantial disruption.

The arrangement of mirrors 56 and the z-axis focal lens 60 cooperate during operation of the remote laser welding apparatus 18 to dictate the desired movement of the laser beam 24 within the operating envelope 58 at the weld site 16 as well as the position of the focal point 62 along the longitudinal axis 64 of the beam 24. The arrangement of mirrors 56, more specifically, includes a pair of tiltable scanning mirrors 68. Each of the tiltable scanning mirrors 68 is mounted on a galvanometer 70. The two tiltable scanning mirrors 68 can move the location at which the laser beam 24 impinges the top surface 20 of the workpiece stack-up 10 anywhere in the x-y plane of the operating envelope 58 through precise coordinated tilting movements executed by the galvanometers 70. At the same time, the z-axis focal lens 60 controls the location of the focal point 62 of the laser beam 24 in order to help administer the laser beam 24 at the correct power density. All of these optical components 60, 68 can be rapidly indexed in a matter of milliseconds or less to advance the laser beam 24 relative to the top surface 20 of the workpiece stack-up 10 at a travel velocity that may reach as high as 120 m/min (meters per minute) while positioning the focal point 62 of the laser beam somewhere between 100 mm above (+100 mm) the top surface 20 of the workpiece stack-up 10 to 100 mm below (−100 mm) the top surface 20 along the longitudinal beam axis 64.

A characteristic that differentiates remote laser spot welding (also sometimes referred to as “welding on the fly”) from other conventional forms of laser spot welding is the focal length of the laser beam 24. Here, as shown in best in FIG. 1, the laser beam 24 has a focal length 72, which is measured as the distance between the focal point 62 and the last tiltable scanning mirror 68 that intercepts and reflects the laser beam 24 prior to the laser beam 24 impinging the top surface 20 of the workpiece stack-up 10 (also the outer surface 26 of the first steel workpiece 12). The focal length 72 of the laser beam 24 is preferably in the range of 0.4 meters to 2.0 meters with a diameter of the focal point 62 typically ranging anywhere from 350 μm to 700 μm. The scanning optic laser head 54 shown generally in FIG. 1 and described above, as well as others that may be constructed somewhat differently, are commercially available from a variety of sources. Some notable suppliers of scanning optic laser heads and lasers for use with the remote laser welding apparatus 18 include HIGHYAG (Kleinmachnow, Germany) and TRUMPF Inc. (Farmington, Conn., USA).

As part of the disclosed laser spot welding method, and referring now to FIGS. 1-3, at least one hole 74 is formed in the workpiece stack-up 10. The at least one hole 74 extends at least part of the way through the workpiece stack-up 10 and traverses the faying interface 34 established between the first and second steel workpieces 12, 14. The at least one hole 74 may be open at the top surface 20 (outer surface 26 of the first steel workpiece 12) of the workpiece stack-up 10 through a top surface entrance opening 76 and my further extend only partially into the second steel workpiece 14 such that the at least one hole 74 does not breach the bottom surface 22 of the workpiece stack-up 10. In an alternative embodiment, the at least one hole 74 may be open at the bottom surface 22 (outer surface 30 of the second steel workpiece 12) of the workpiece stack-up 10 through a bottom surface entrance opening 78 and my further extend only partially into the first steel workpiece 12 such that the at least one hole 74 does not breach the top surface 20 of the workpiece stack-up 10. In a preferred embodiment, however, the at least one hole 74 fully penetrates the workpiece stack-up 10 and, accordingly, extends entirely through both the first and second steel workpieces 12, 14 such that the hole 74 is open at both the top and bottom surfaces 20, 22 of the workpiece stack-up 10 through the top and bottom surface entrance openings 76, 78, respectively, as shown in FIG. 3.

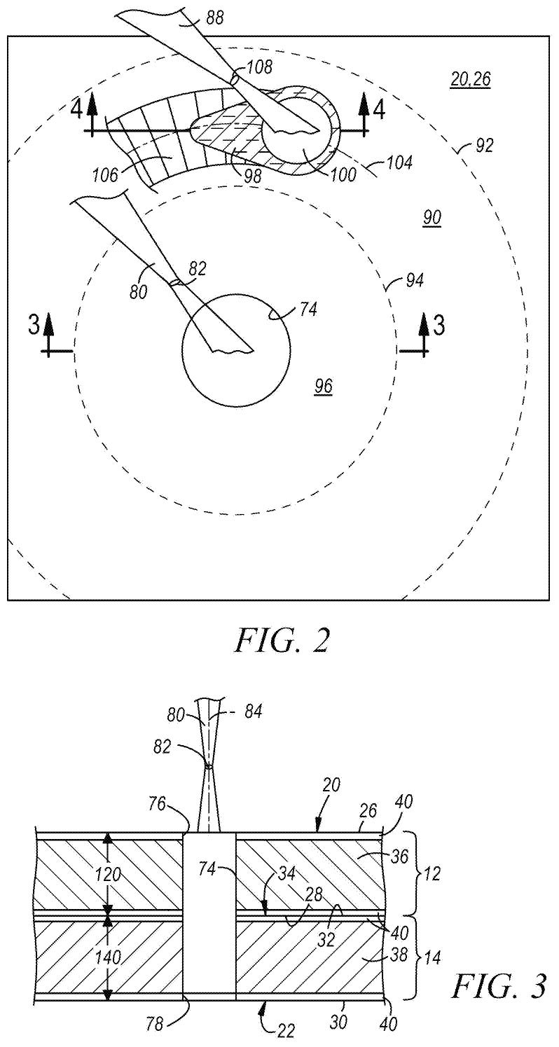

The at least one hole 74 is preferably formed by operation of the remote laser welding apparatus 18. As illustrated best in FIGS. 2-3, the laser beam 24 associated with the remote laser welding apparatus 18 is configured as a pre-welding laser beam 80 that is suited to form the at least one hole 74. The pre-welding laser beam 80 is directed at, and impinges, the top surface 20 of the workpiece stack-up 10 within the weld site 16, and is provided with a set of beam characteristics that enables the formation of the at least one hole 74. For example, the pre-welding laser beam 80 may have a power level in the range 1 kW to 10 kW and a focal point 82 of the pre-welding laser beam 80 may be moved along a longitudinal axis 84 of the beam 84 from an initial location of between +50 mm and −20 mm to a final location of between +20 mm and −10 mm relative to the top surface of the workpiece stack-up over a period of 20 ms to 2000 ms. Such beam characteristics have the effect of vaporizing the first and second steel workpieces 12, 14 and expelling molten steel from the workpiece stack-up 10 to leave behind the at least one hole 74 which, as mentioned before, preferably fully penetrates the stack-up 10 by extending entirely through the stack-up between the top and bottom surface entrance openings 76, 78. The pre-welding laser beam 80 may also be moved relative to a plane of the top surface 20 (i.e., in the x-y plane of the top surface 20) to achieve the desired size of the at least one hole 74.

The at least one hole 74 has a diameter that preferably ranges from 2 mm to 4 mm, although smaller and larger diameters may be instituted based on the specifics of the workpiece stack-up 10 and the subsequent formation of a laser spot weld joint. Moreover, the at least one hole 74 may be comprised of a plurality of similar holes 74 that are grouped together. Anywhere from one to eight holes 74 may be formed in the workpiece stack-up 10 prior to laser welding. Additionally, within the grouping of a plurality of holes 74, some or all of the holes 74 may be formed by the pre-welding laser beam 80 as described above. Furthermore, the grouped holes 74 may be the same or different in terms of their penetration depth and size. To be sure, in one embodiment, all of the plurality of holes 74 may fully penetrate the workpiece stack-up 10 and have a diameter between 2 mm and 4 mm. In other embodiments, however, only some of the holes 74 may fully penetrate the workpiece stack-up 10 while others may only partially penetrate the stack-up 10 from either the top or bottom surfaces 20, 22.

After the at least one hole 74 is formed, the workpiece stack-up is laser spot welded by operation of the remote laser welding apparatus 18 to form a laser spot weld joint 86 (FIG. 1) that fusion welds the steel workpieces 12, 14 together at the weld site 16. To transition the remote laser welding apparatus 18 from operating to form the at least one hole 74 to operating to form the laser spot weld joint 86, the laser beam 24 of the apparatus 18 is switched from being configured as the pre-welding laser beam 80 to being configured as a welding laser beam 88, as illustrated in FIGS. 2 and 4. Once activated, the welding laser beam 88 is directed at, and impinges, the top surface 20 of the workpiece stack-up 10 within an annular weld area 90 as projected onto the plane (the x-y plane) of the top surface 20. The annular weld area 90 is defined by an outer diameter boundary 92 and an inner diameter boundary 94 on the plane of the top surface 20 and surrounds a center area 96 that spans the at least one hole 74. The center area 96 is said to “span” the at least one hole 74 (and all of the plurality of grouped holes 74 if more than one hole 74 is present) when an imaginary extension of the center area 96 from the top surface 20 to the bottom surface 22 of the workpiece stack-up 10 delineates a volume within the stack-up 10 that encompasses the previously-formed hole(s) 74. The outer diameter boundary 92 preferably ranges in diameter from 5 mm to 15 mm while the inner diameter boundary 94 preferably ranges in diameter from 3 mm to 12 mm.

The heat generated from absorption of the focused energy of the welding laser beam 88 initiates melting of the first and second metal workpieces 12, 14 to create a molten steel weld pool 98 that penetrates into the workpiece stack-up 10 from the top surface 20 towards the bottom surface 22. The molten steel weld pool 98 penetrates far enough into the workpiece stack-up 10 that it intersects the faying interface 34 established within the workpiece stack-up 10 between the first and second steel workpieces 12, 14. The welding laser beam 88, moreover, preferably has a power density sufficient to vaporize the workpiece stack-up 10 directly beneath where it impinges the top surface 20 of the stack-up 10. This vaporizing action produces a keyhole 100, which is a column of vaporized workpiece steel that usually contains plasma. The keyhole 100 is formed within the molten steel weld pool 98 and also penetrates into the workpiece stack-up 10 from the top surface 20 towards the bottom surface 22 and intersects the faying interface 34 within the workpiece stack-up 10. The keyhole 100 and the surrounding molten steel weld pool 98 may fully (as shown) or partially penetrate the workpiece stack-up 10.

After the molten steel weld pool 98 and the keyhole 100 are created, the welding laser beam 88 is advanced relative to the plane of the top surface 20 of the workpiece stack-up along a beam travel pattern 102 (FIGS. 5-8) confined to the annular weld area 90. Advancement of the welding laser beam 88 along the beam travel pattern 102 is managed by precisely controlling the coordinated movements of the tiltable scanning mirrors 68 of the scanning optic laser head 54. Such coordinated movements of the scanning mirrors 68 can rapidly move the welding laser beam 88 to trace a wide variety of beam travel patterns of simple or complex shape as projected onto the plane of the top surface 20 of the workpiece stack-up 10. Some examples of suitable beam travel patterns 102 that may be traced by the welding laser beam 88 are shown in FIGS. 5-8 and described below. In general, however, and using FIGS. 5-8 as examples, the beam travel pattern 102 includes one or more nonlinear weld paths 104. What is more, the welding laser beam 88 is preferably advanced along the designated beam travel pattern 102 at a relatively high travel velocity that ranges between 2 m/min and 120 m/min or, more narrowly, between 8 m/min and 50 m/min.

As noted above, the beam travel pattern 102 is traced by the welding laser beam 88 with respect to a plane oriented along the top surface 20 of the workpiece stack-up 10 inside the annular weld area 90 and around the center area 96 that spans the at least one hole 74. As such, the illustrations presented in FIGS. 5-8 are plan views, from above, of various exemplary beam travel patterns projected onto the top surface 20 of the workpiece stack-up 10. These views provide a visual understanding of how the welding laser beam 88 is advanced relative to the top surface 20 of the workpiece stack-up 10 during formation of the laser spot weld joint 86. The one or more nonlinear weld paths 104 within the beam travel pattern 102 may include a single weld path or a plurality of weld paths that include some curvature or deviation from linearity. Such weld paths may be continuously curved or they may be comprised of multiple straight line segments that are connected end-to-end at an angle to one another (i.e., the angle between the connected line segments ≠180°).

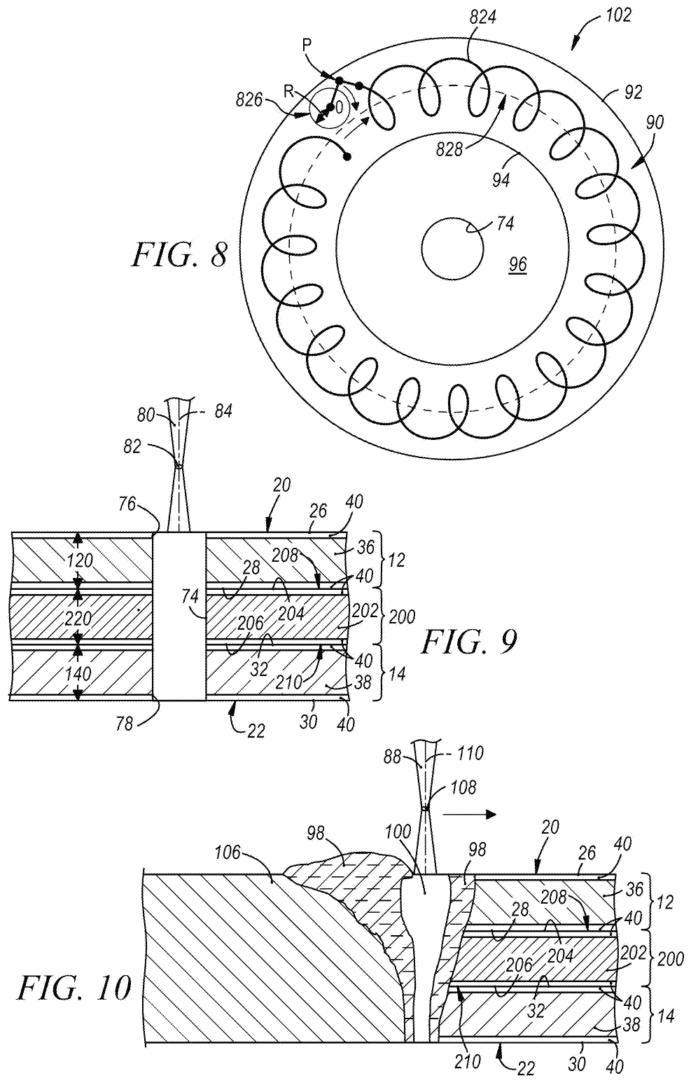

Referring now to FIGS. 5-8, the beam travel pattern 102 may comprise a closed-curve beam travel pattern, a spiral beam travel pattern, or some other beam travel pattern. A closed-curve beam travel pattern may be any pattern that includes a plurality of radially-spaced and unconnected circular weld paths, elliptical weld paths, or weld paths having like closed curves. A spiral beam travel pattern may be any pattern having a single weld path that revolves around the inner diameter boundary 94 of the annular weld area 90 and includes multiple turnings that are radially spaced apart between the outer and inner diameter boundaries 92, 94 with a preferred number of spiral turnings ranging from two to twenty. A wide variety of other patterns can also be employed as the beam travel pattern 102 including, for example, the roulette beam travel pattern shown in FIG. 8 that includes an epitrochoidal weld path. Variations of these specifically illustrated beam travel patterns 102 as well as other patterns that include nonlinear weld paths may also be traced by the welding laser beam 88 to form the laser spot weld joint 86.

FIG. 5 illustrates an embodiment of the beam travel pattern 102 that comprises a single nonlinear inner weld path 802 that lies within the annular weld area 90 in the form of a spiral beam travel pattern 800. Here, as shown, the spiral beam travel pattern 800 originates at a fixed inner point 804, encircles the center area 96 while revolving around the inner diameter boundary 94 of the annular weld area 90, and ends at a fixed outer point 806. The single nonlinear weld path 802 of the spiral beam travel pattern 800 thus revolves around and expands radially outwardly from the fixed inner point 804 to the fixed outer point 806. The single nonlinear weld path 802 may be continuously curved, as shown in FIG. 5, and the spiral beam travel pattern 800 may further be an Archimedean spiral in which the turnings of the weld path 802 are spaced equidistantly from each other by a distance D. This distance D may be referred to as a step size and it may range between 0.01 mm and 0.8 mm as measured between radially-aligned points A, B on each pair of adjacent turnings. Alternatively, as another example, the single nonlinear weld path 802 may be arranged into an equiangular spiral beam travel pattern in which adjacent turnings of the spiral get progressively farther apart. One example of an equiangular spiral beam travel pattern is defined by the equation r(θ)=e^{-0.1(θ)} in which theta is defined in polar coordinates.

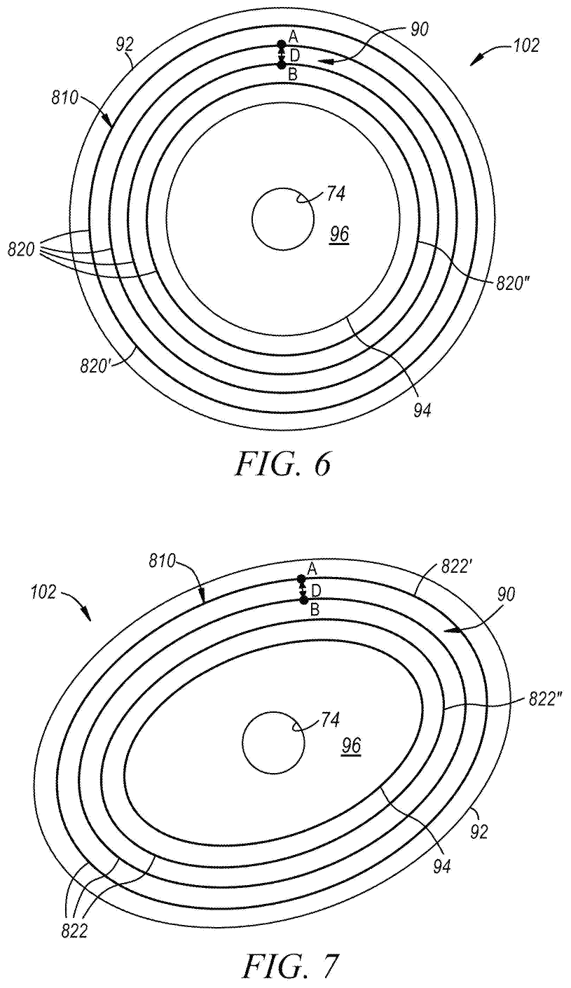

FIGS. 6-7 illustrate several embodiments of the beam travel pattern 102 that comprise a plurality of nonlinear weld paths that are distinct from each other in that none of the nonlinear weld paths intersect. Each of the beam travel patterns 102 shown in FIGS. 6-7, for example, comprises a plurality of radially-spaced and unconnected circular weld paths 820 (FIG. 6) or unconnected elliptical weld paths 822 (FIG. 7) in the form of a closed-curve beam travel pattern 810. The circular weld paths 820 and the elliptical weld paths 822 are radially spaced apart on the top surface 20 of the workpiece stack-up 10 and are concentrically arranged about the center area 96. These discrete weld paths 820, 822 may be radially spaced evenly apart (FIGS. 6-7) or they may be spaced apart at varying distances between the outer and inner diameter boundaries 92, 94. In that regard, the circular weld paths 820 include an outermost circular weld path 820′ located proximate the outer diameter boundary 92 of the annular weld area 90 and an innermost circular weld path 820″ located proximate the inner diameter boundary 94. The elliptical weld paths 822 include similarly located outermost and innermost elliptical weld paths 822′, 822″. The embodiments of the beam travel pattern 810 illustrated in FIGS. 6-7 preferably include anywhere from two to twenty weld paths 820, 822 or, more narrowly, anywhere from three to eight weld paths 820, 822. And, like the spiral beam travel pattern 800 of FIG. 5, the distance D between radially-aligned points A, B on adjacent circular or elliptical weld paths 820, 822 (or step size) preferably ranges from 0.01 mm to 0.8 mm.

Other embodiments of the beam travel pattern 102 are indeed contemplated in addition to those shown in FIGS. 5-7. In one such embodiment, which is depicted in FIG. 8, the beam travel pattern 102 is roulette beam travel pattern that includes an epitrochoidal weld path 824. The epitrochoidal weld path 824 can be represented by a path traced by a point P attached to the origin O of a rotating circle 826 of radius R rolling around the outside of a fixed circle 828. As the rotating circle 826 rotates in a clockwise direction about the fixed circle 828 such that the circumference of the rotating circle 826 meets the circumference of the fixed circle 828, the point P moves along with the circle 826 creating the epitrochoidal weld path 824 depicted in FIG. 8. The rotating circle 826 can rotate along the fixed circle 828 so that it moves point P continuously around the center area 96 within the annular weld area 90. Different epitrochoidal weld paths having shapes other than the one shown in FIG. 8 can be created by altering the distance between point P and the origin O of the rotating circle 826, by changing the radius R of the rotating circle 826, and/or by changing the diameter of the fixed circle 828.

The welding laser beam 88 may be advanced along the beam travel pattern 102 within the annular weld area 90 in a variety of ways. For example, with respect to the spiral beam travel pattern 800 shown in FIG. 5, the welding laser beam 88 may be advanced from the fixed outer point 806 nearest the outer diameter boundary 92 and around the several turnings of the single nonlinear weld path 802 until it eventually stops at the fixed inner point 804 nearest the inner diameter boundary 94. As another example, with respect to the closed-curved beam travel patterns 810 shown in FIGS. 6-7, the welding laser beam 88 may be advanced in a radially inward direction from the outermost weld path 820′, 822′ nearest the outer diameter boundary 92 to the innermost weld path 820″, 822″ nearest the inner diameter boundary 94. The advancement of the welding laser beam 88 in a radially inward direction within the annular weld area 90—particularly when the beam travel pattern includes a spiral beam travel pattern or a closed-curved beam travel pattern—is generally preferred since the patterned inward movement of the welding laser beam 88 along the beam travel pattern 102 helps drive zinc vapors created by the heat of the welding laser beam 88 towards the at least one hole 74 where they can escape from the workpiece stack-up 10.

As the welding laser beam 88 is being advanced along the beam travel pattern 102, which is depicted best in FIGS. 2 and 4, the keyhole 100 and the molten steel weld pool 98 are consequently translated at the same speed along a corresponding route relative to the top surface 20 since they track the movement of the welding laser beam 88 along the top surface 20. In this way, the molten steel weld pool 98 momentarily leaves behind a trail of molten steel workpiece material in the wake of the travel path of the welding laser beam 88 and the corresponding route of the weld pool 98. This trail of molten steel workpiece material quickly solidifies into resolidified composite steel workpiece material 106 (FIGS. 2 and 4) that is comprised of material derived from each of the steel workpieces 12, 14 penetrated by the molten steel weld pool 98. Eventually, when the welding laser beam 88 is finished tracing the beam travel pattern 102, the transmission of the welding laser beam 88 is terminated so that the beam 88 no longer transfers energy to the workpiece stack-up 10. At this time, the keyhole 100 collapses and the molten steel weld pool 98 solidifies. The collective resolidified composite steel workpiece material 106 obtained from advancing the welding laser beam 88 along the beam travel pattern 102 constitutes the laser spot weld joint 86.

The depth of penetration of the keyhole 100 and the surrounding molten steel weld pool 98 is controlled during advancement of the welding laser beam 88 along the beam travel pattern 102 to ensure the steel workpieces 12, 14 are fusion welded together by the weld joint 86 at the weld site 16. In particular, as mentioned above, the keyhole 100 and the molten steel weld pool 98 intersect the faying interface 34 established between the first and second steel workpieces 12, 14 within the workpiece stack-up 10. In fact, in a preferred embodiment, as shown best in FIG. 4, the keyhole 100 and the molten steel weld pool 98 fully penetrate the workpiece stack-up 10, meaning that both the keyhole 100 and the molten steel weld pool 98 extend from the top surface 20 all the way through the stack-up 10 so as to breach through the bottom surface 22. By causing the keyhole 100 and the molten steel weld pool 98 to penetrate far enough into the workpiece stack-up 10 that they intersect the faying interface 34—either by way of full or partial penetration—the resolidified composite steel workpiece material 106 produced by advancing the welding laser beam 88 along the beam travel pattern 102 serves to autogenously fusion weld the steel workpieces 12, 14 together.

The depth of penetration of the keyhole 100 and the surrounding molten steel weld pool 98 can be attained by controlling various characteristics of the welding laser beam 88 including the power level of the laser beam 88, the position of a focal point 108 of the laser beam 88 along a longitudinal axis 110 of the beam 88, and the travel velocity of the laser beam 88 when being advanced along the beam travel pattern 102. These beam characteristics can be programmed into a weld controller capable of executing instructions that dictate the penetration depth of the keyhole 100 and the surrounding molten steel weld pool 98 with precision. While the various characteristics of the welding laser beam 88 can be instantaneously varied in conjunction with one another to attain the penetration depth of the keyhole 100 and the molten steel weld pool 98 at any particular portion of the beam travel pattern 102, in many instances, regardless of the profile of the beam travel pattern 102, the power level of the welding laser beam 88 may be set to between 0.2 kW and 50 kW, or more narrowly between 1 kW and 10 kW, the travel velocity of the welding laser beam 88 may be set to between 2 m/min and 120 m/min or, more narrowly, between 8 m/min and 50 m/min, and the focal point 108 of the welding laser beam 88 may be set somewhere between 30 mm above the top surface 20 (+30 mm) of the workpiece stack-up 10 and 30 mm below (−30 mm) the top surface 20.

Without being bound by theory, the formation of the at least one hole 74 in the workpiece stack-up followed by the advancement of the welding laser beam 88 along the beam travel pattern 102 within the annular weld area 90 is believed to promote good strength—in particular good peel and cross-tension strength—in the laser spot weld joint 86. Specifically, the formation of the at least one hole 74 provides a conduit within the workpiece stack-up 10 through which zinc vapors created by the welding laser beam 24 can quickly escape. Such an escape conduit reduces the chance that high-pressure zinc vapors will infiltrate and become trapped in the molten steel weld pool 98 which, in turn, helps avoid the presence of entrained porosity within the resolodified composite steel workpiece material 106 of the laser spot weld joint 86. Additionally, the formation of the at least one hole 74, if effectuated by laser welding, can burn away zinc from the workpiece stack-up 10 at the weld site 16 and also convert zinc into high boiling temperature zinc oxides within the weld site 16, each of which reduces the amount of zinc vapor that can be subsequently generated by the welding laser beam 88.

Moreover, the advancement of the laser welding beam 88 along the beam travel pattern 102 within the annular weld area 90 has the effect of driving any zinc vapors that may be generated in a radially inward direction towards the at least one hole 74. The consolidation and induced guidance of zinc vapors towards the at least one hole 74 occurs either along the faying interface 34 if the portion of the workpiece stack-up 10 beneath the center area 96 does not melt and/or through molten steel if some or all of the portion of the stack-up 10 beneath the center area 96 does melt as a result of conductive heat transfer. By guiding zinc vapors towards the at least one hole 74, the advancement of the welding laser beam 88 along the beam travel pattern 102 limits or altogether eliminates entrained porosity within the resolodified composite steel workpiece material 106 of the laser spot weld joint 86. And, even if some porosity is present, the patterned movement of the welding laser beam 88 within the annular weld area 90 sweeps at least a significant portion of that porosity into a region of the laser spot weld joint 86 beneath the center area 96 on the plane of the top surface 20 of the workpiece stack-up 10. The concentration of porosity beneath the center area 96 is tolerable since centrally-located porosity is less likely to affect the mechanical properties of the laser spot weld joint 86 compared to porosity located at the perimeter of the weld joint 86.

FIGS. 1 and 3-4 illustrate the above-described embodiments of the disclosed method in the context of the workpiece stack-up 10 being a “2T” stack-up that includes only the first and second steel workpieces 12, 14 with their single faying interface 34. The same laser spot welding method, however, may also be carried out when the workpiece stack-up 10 is a “3T” stack-up that includes an additional third steel workpiece 200, with a thickness 220, that overlaps and is situated between the first and second steel workpieces 12, 14, as depicted in FIGS. 9-10. In fact, regardless of whether the workpiece stack-up 10 is a 2T or a 3T stack-up, the laser spot welding method does not have to be modified all that much to form the laser spot weld joint 86. And, in each instance, the laser spot weld joint 86 can achieve good quality strength properties despite the fact that at least one, and sometimes all, of the steel workpieces includes a surface coating 40 comprised of a zinc-based material such as zinc (e.g., galvanized or electrogalvanized) or a zinc-iron alloy (e.g., galvanneal).

Referring now to FIGS. 9-10, the additional third steel workpiece 200, if present, includes a third base steel substrate 202 that may be optionally coated with the same surface coating 40 described above. When the workpiece stack-up 10 includes the first, second, and third overlapping steel workpieces 12, 14, 200, the base steel substrate 36, 38, 202 of at least one of the workpieces 12, 14, 200, and sometimes all of them, includes the surface coating 40. As for the characteristics (e.g., composition, thickness, etc.) of the third base steel substrate 202, the descriptions above regarding the first and second base steel substrates 36, 38 are equally applicable to that substrate 202 as well. It should be noted, though, that while the same general descriptions apply to the several steel workpieces 12, 14, 200, there is no requirement that the steel workpieces 12, 14, 200 be identical to one another. In many instances, the first, second, and third steel workpieces 12, 14, 200 are different in some aspect from each other whether it be composition, thickness, and/or form.

As a result of stacking the first, second, and third steel workpieces 12, 14, 200 in overlapping fashion to provide the workpiece stack-up 10, the third steel workpiece 200 has two faying surfaces 204, 206. One of the faying surfaces 204 overlaps and confronts the first faying surface 28 of the first steel workpiece 12 and the other faying surface 206 overlaps and confronts the second faying surface 32 of the second steel workpiece 14, thus establishing two faying interfaces 208, 210 within the workpiece stack-up 10 that extend through the weld site 16. These faying interfaces 208, 210 are the same type and encompass the same attributes as the faying interface 34 already described with respect to FIGS. 3-4. Consequently, in this embodiment as described herein, the outer surfaces 26, 30 of the flanking first and second steel workpieces 12, 14 still face away from each other in opposite directions and constitute the top and bottom surfaces 20, 22 of the workpiece stack-up 10.

The formation of the at least one hole 74 and, subsequently, the laser spot weld joint 86 in the “3T” workpiece stack-up 10 are achieved in the same manner as previously described. The formation of the at least one hole 74, for example, extends at least part of the way through the workpiece stack-up 10 and traverses each of the faying interfaces 208, 210 established between the several steel workpieces 12, 14, 200. The at least one hole 74 preferably extends entirely through the first, second, and third steel workpieces 12, 14, 200 such that the hole 74 is open at both the top and bottom surfaces 20, 22 of the workpiece stack-up 10 through the top and bottom surface entrance openings 76, 78, respectively, as shown in FIG. 9. Still further, as before, the at least one hole 74 can be formed in a variety of ways including through operation of the remote laser welding apparatus 18 and use of the pre-welding laser beam 80. The at least one hole 74 has diameter that preferably ranges from 2 mm to 4 mm, although other diameters may certainly be employed. More than one hole 74 may be also be formed, if desired, as previously described.

The formation of the laser spot weld joint 86 is carried out by advancing the welding laser beam 88, preferably though operation of the remote laser welding apparatus 18, along the beam travel pattern 102 within the annular weld area 90 as discussed above. Such advancement of the welding laser beam 88 translates the optional keyhole 100 and the surrounding molten steel weld pool 98 along a corresponding route to ultimately yield the resolidified composite steel workpiece material 106 that collectively constitutes the laser spot weld joint 86 and fusion welds the three steel workpieces 12, 14, 200 together. And, like before, in a preferred embodiment, the keyhole 100 and the surrounding molten steel weld pool 98 fully penetrate the workpiece stack-up 10, as shown in FIG. 10, although in alternative embodiments the keyhole 100 and the molten steel weld pool 98 may only partially penetrate the stack-up 10. Any of the exemplary beam travel patterns 102 depicted in FIGS. 5-8, as well others not depicted, may be traced by the advancing welding laser beam 88 during formation of the laser spot weld joint 86 to achieve the same effects related to zinc vapor escape through the at least one hole 74 and porosity minimization within the joint 86 as previously discussed.

The above description of preferred exemplary embodiments and specific examples are merely descriptive in nature; they are not intended to limit the scope of the claims that follow. Each of the terms used in the appended claims should be given its ordinary and customary meaning unless specifically and unambiguously stated otherwise in the specification.

1. A method of laser spot welding a workpiece stack-up that includes at least two overlapping steel workpieces, the method comprising:
providing a workpiece stack-up that includes overlapping steel workpieces, the workpiece stack-up comprising at least a first steel workpiece and a second steel workpiece, the first steel workpiece providing a top surface of the workpiece stack-up and the second steel workpiece providing a bottom surface of the workpiece stack-up, wherein a faying interface is established between each pair of adjacent overlapping steel workpieces within the workpiece stack-up, and wherein at least one of the steel workpieces in the workpiece stack-up includes a surface coating of a zinc-based material;
forming at least one hole in the workpiece stack-up that extends at least part of the way through the workpiece stack-up and traverses each faying interface established within the workpiece stack-up, the at least one hole being open at the top surface of the workpiece stack-up, the bottom surface of the workpiece stack-up, or at both the top and bottom surfaces of the workpiece stack-up;
directing a welding laser beam at the top surface of the workpiece stack-up, the welding laser beam impinging the top surface and creating a molten steel weld pool that penetrates into the workpiece stack-up from the top surface towards the bottom surface and that intersects each faying interface established within the workpiece stack-up; and
forming a laser weld joint by advancing the welding laser beam relative to a plane of the top surface of the workpiece stack-up along a beam travel pattern that lies within an annular weld area defined by an inner diameter boundary and an outer diameter boundary on the plane of the top surface, the beam travel pattern of the welding laser beam surrounding a center area on the plane of the top surface that spans the at least one hole formed in the workpiece stack-up.

2. The method set forth in claim 1, wherein the first steel workpiece has an outer surface and a first faying surface, and the second steel workpiece has an outer surface and a second faying surface, the outer surface of the first steel workpiece providing the top surface of the workpiece stack-up and the outer surface of the second steel workpiece providing the bottom surface of the workpiece stack-up, and wherein the first and second faying surfaces of the first and second steel workpieces overlap and confront to establish a first faying interface.

3. The method set forth in claim 1, wherein the first steel workpiece has an outer surface and a first faying surface, and the second steel workpiece has an outer surface and a second faying surface, the outer surface of the first steel workpiece providing the top surface of the workpiece stack-up and the outer surface of the second steel workpiece providing the bottom surface of the workpiece stack-up, and wherein the workpiece stack-up comprises a third steel workpiece situated between the first and second steel workpieces, the third steel workpiece having opposed faying surfaces, one of which overlaps and confronts the first faying surface of the first steel workpiece to establish a first faying interface and the other of which overlaps and confronts the second faying surface of the second steel workpiece to establish a second faying interface.

4. The method set forth in claim 1, wherein the at least one hole in the workpiece stack-up is formed by directing a pre-welding laser beam at the top surface of the workpiece stack-up to expel molten steel from within the stack-up.

5. The method set forth in claim 4, wherein the pre-welding laser beam has a power level that ranges from 1 kW to 10 kW, and wherein a focal point of the pre-welding laser beam is moved from an initial location of between +50 mm and −20 mm to a final location of between +20 mm and −10 mm relative to the top surface of the workpiece stack-up.

6. The method set forth in claim 1, wherein the at least one hole in the workpiece stack-up is formed by mechanical drilling.

7. The method set forth in claim 1, wherein the at least one hole fully penetrates the workpiece stack-up such that the hole extends between, and is open at, both the top and bottom surfaces of the workpiece stack-up.

8. The method set forth in claim 1, wherein the at least one hole has a diameter that ranges from 2 mm to 4 mm.

9. The method set forth in claim 1, wherein forming the at least one hole comprises forming a plurality of holes.

10. The method set forth in claim 1, wherein advancing the welding laser beam along the beam travel pattern is performed by a scanning optic laser head having tiltable scanning mirrors whose movements are coordinated to move the welding laser beam relative to the plane of the top surface of the workpiece stack-up.

11. The method set forth in claim 10, wherein the welding laser beam is advanced along the beam travel pattern at a travel speed that ranges from 8 m/min to 50 m/min.

12. The method set forth in claim 1, wherein the beam travel pattern of the welding laser beam is a spiral beam travel pattern that comprises a single nonlinear weld path that revolves around and expands radially outwardly from a fixed inner point proximate the inner diameter boundary to a fixed outer point proximate the outer diameter boundary of the annular weld area.

13. The method set forth in claim 12, wherein a step size between radially-aligned points on each pair of adjacent turnings of the spiral beam travel pattern is greater than 0.01 mm and less than 0.8 mm.

14. The method set forth in claim 12, wherein the welding laser beam is advanced along the spiral beam travel pattern from the fixed outer point proximate the outer diameter boundary of the annular weld area to the fixed inner point proximate the inner diameter boundary.

15. The method set forth in claim 1, wherein the beam travel pattern of the welding laser beam is a closed-curve beam travel pattern that comprises a plurality of radially spaced and unconnected circular or elliptical weld paths that are concentrically arranged about the center area.

16. The method set forth in claim 15, wherein a step size between radially-alinged points of each pair of adjacent circular or elliptical weld paths is greater than 0.01 mm and less than 0.8 mm.

17. The method set forth in claim 15, wherein the welding laser beam is advanced along the closed-curve beam travel pattern in a radially inward direction from an outermost weld path proximate the outer diameter boundary of the annular weld area to an innermost weld path proximate the inner diameter boundary.

18. The method set forth in claim 1, wherein a diameter of the inner diameter boundary of the annular weld area ranges from 3 mm to 12 mm and a diameter of the outer diameter boundary ranges from 5 mm to 15 mm.

19. A method of remote laser spot welding a workpiece stack-up that includes at least two overlapping steel workpieces, the method comprising:
providing a workpiece stack-up that includes overlapping steel workpieces, the workpiece stack-up comprising at least a first steel workpiece and a second steel workpiece, the first steel workpiece providing a top surface of the workpiece stack-up and the second steel workpiece providing a bottom surface of the workpiece stack-up, wherein a faying interface is established between each pair of adjacent overlapping steel workpieces within the workpiece stack-up, and wherein at least one of the steel workpieces in the workpiece stack-up includes a surface coating of zinc or a zinc-iron alloy;
operating a scanning optic laser head to direct a solid-state pre-welding laser beam at the top surface of the workpiece stack-up, the pre-welding laser beam impinging the top surface and expelling molten steel from within the stack-up to form at least one hole in the workpiece stack-up that extends at least part of the way through the workpiece stack-up and traverses each faying interface established within the workpiece stack-up, the at least one hole being open at the top surface of the workpiece stack-up, the bottom surface of the workpiece stack-up, or at both the top and bottom surfaces of the workpiece stack-up;
operating the scanning optic laser head to direct a welding laser beam at the top surface of the workpiece stack-up after formation of the at least one hole, the welding laser beam impinging the top surface within an annular weld area defined by an inner diameter boundary and an outer diameter boundary on the plane of the top surface to create a molten steel weld pool that penetrates into the workpiece stack-up from the top surface towards the bottom surface, the annular weld area surrounding a center area on the plane of the top surface and that spans the at least one hole formed in the workpiece stack-up; and
coordinating the movement of tiltable scanning mirrors within the scanning optic laser head to advance the welding laser beam relative to the plane of the top surface of the workpiece stack-up and along a beam travel pattern that lies within the annular weld area and surrounds the center area that spans the at least one hole, and wherein the welding laser beam is advanced along the beam travel pattern at a travel speed that ranges from 2 m/min to 120 m/min.

20. The method set forth in claim 19, wherein the at least one hole has a diameter that ranges from 2 mm to 4 mm, and wherein a diameter of the inner diameter boundary of the annular weld area ranges from 3 mm to 12 mm and a diameter of the outer diameter boundary ranges from 5 mm to 15 mm.
